(19) United States
(12) Patent Application Publication
(10) Pub. No.: US 2021/0277868 A1
(43) Pub. Date: Sep. 9, 2021

(54) MULTIROTOR WIND TURBINE POWER BOOST STRATEGY

(71) Applicant: VESTAS WIND SYSTEMS A/S, Aarhus N (DK)

(72) Inventor: Søren DALSGAARD, Hadsten (DK)

(21) Appl. No.: 17/259,459

(22) PCT Filed: Jul. 2, 2019
(86) PCT No.: PCT/DK2019/050212

§ 371 Date: Jan. 11, 2021

(30) Foreign Application Priority Data
Jul. 9, 2018 (DK) PA 2018 70475

(51) Int. Cl. F03D 7/02; F03D 1/02; F03D 17/00

(52) U.S. Cl. CPC F03D 7/028; F03D 1/02; F05B 2270/335; F05B 2270/1033; F05B 2240/37; F03D 17/00

(57) ABSTRACT

The present invention is directed to operation of a multi-rotor wind turbine comprising at least two rotors. Each rotor has a rated capacity. The method comprises monitoring a power output of the rotors, detecting that the power output of at least a first one of the rotors is below its rated capacity, detecting that the power output of at least a second one of the rotors is at its rated capacity, and controlling operation of the second rotor, such as to temporarily increase its power output to a value above its rated capacity.

### FIELD OF THE INVENTION

The invention relates to a method of operating a multirotor wind turbine. The invention further relates to a multirotor wind turbine.

### BACKGROUND OF THE INVENTION

In a wind turbine, kinetic energy from the wind is converted into electrical energy via a rotor that is coupled to a generator, usually via a gearbox. A power converter (also called ‘converter’) converts the generator output to electrical power suitable for delivery to the grid. An important parameter of a wind turbine is its annual energy production (AEP). The AEP of a wind turbine depends on the wind speed during the year and the maximum power output the generator is able to deliver over a sustained period of time. This maximum power output is generally called rated power. The wind speed at which the rated output power is reached is called rated wind speed. At wind speeds below rated wind speed, the wind turbine operates at its maximum efficiency. At wind speeds above rated wind speed, the rotor speed is typically controlled near a constant reference while keeping the power output at the rated power level and to avoid damage to the various parts of the wind turbine. Not limiting the rotor speed above at higher wind speeds would, e.g., lead to overheating of the generator or the converter.

Many modern wind turbines can be operated in a power boost mode in which the power output is temporarily allowed to exceed the power rating. Power boosts are typically initiated when the wind turbine has been operating below rated power and the wind speed comes back to above rated speed. Under the correct circumstances, the power boost can compensate for the “lost” power in periods of below rated speed wind speeds. During a power boost, the turbine's nominal power output may be increased by up to about 5% by adjusting the rotor pitch in order to increase the rotational speed of the rotor. In order not to damage the rotor, the power boost is only active for a short time period of, e.g., 20-60 seconds. After the power boost, a recovery period allows, e.g., the generator and the converter to cool down to normal operating temperatures.

Two exemplary patent applications wherein aspects of a power boost control strategy are described are WO 2917 059862 A1 and WO 2016 206698 A1. In the former, model predictive control is used for controlling the use of the power boost function. In the latter, a control process for optimizing the power gains from a power boost without compromising on operational safety.

Another recent development in wind turbine technology is the building of multirotor wind turbines in which one wind turbine tower carries multiple, separate rotors. The separate rotors may be provided on the outer ends of arms extending from the wind turbine tower, but other structural designs, with or without central wind turbine tower, are also possible. In the following, the term rotor will, as is common in this technical field, not only be used to refer to the combination of rotor blades and rotor hub, but also to the full power producing unit or system converting wind energy to electrical energy. Single and multirotor wind turbines may operate as standalone power generators or in larger wind turbine parks.

### SUMMARY OF THE INVENTION

According to a first aspect of the invention this object is achieved by providing a method of operating a multi-rotor wind turbine, the wind turbine comprising a wind turbine support structure and a collection of wind turbine rotors comprising at least two rotors, at least one of the rotors being located at a position away from a central longitudinal axis of the wind turbine support structure, each rotor having a rated capacity. The method comprises the steps of monitoring a power output of the rotors, detecting that the power output of at least a first one of the rotors is below its rated capacity, detecting that the power output of at least a second one of the rotors is at its rated capacity, and controlling operation of the second rotor, such as to temporarily increase its power output to a value above its rated capacity.

In a single rotor wind turbine, the lost power during a sudden drop in the wind speed can only be compensated by a power boost after the wind speed returns to above the rated speed again. Although the average power output of the wind turbine will still be at or below the rated power output, it will be above the rated power output for the duration of the power boost. The thereby added mechanical and thermal stress on the powertrain and power electronics may still have a (small) detrimental effect on the durability of the wind turbine and the fluctuating power output may not be optimal for the connection to the power grid.

With the method according to the invention, the inventors take advantage of the variation in wind conditions between the different rotors in a multirotor wind turbine. Instead of just applying the known power boost strategy to each individual rotor of the collection of wind turbine rotors, a coordinated approach is used wherein the compensating power boost can be distributed over multiple rotors and timed in order to minimize fluctuations in the total wind turbine power output. Important advantages of the invention are a higher power boost capacity with less added mechanical and thermal stress and less fluctuations in the total wind turbine power output. For example, when the wind speed at the first rotor drops below its rated speed while the wind speed at the second rotor is still above its rated speed, a power boost at the second rotor can start immediately, thereby compensating for the drop in wind speed while it happens and stabilizing the total power output of the collection of wind turbine rotors.

An important advantage of the current invention is that the collection of rotors can operate at its nominal power output level at lower average and local wind speeds and can do this without needing to exceed this nominal power out level in order to do so. In the known single rotor power boost scenario, a rotor can only extend the wind speed range over which the average power output is at the nominal power output level. Short-term power drops are later compensated by short-term power boosts. With the collective approach according to the invention, also the actual power output can remain at the nominal output level when the wind speed at one or more of the rotors drops below the rated speed of the rotors. As a result, the rated speed of the collection of rotors is lower than the rated speed of the individual rotors.

In a collection of wind turbine rotors that further comprises at least a third rotor with a rated capacity, the method may further comprise a step of detecting that the power output of the third rotor is at its rated capacity, and controlling operation of the third rotor, such as to temporarily increase its power output to a value above its rated capacity. In this event, a power boost is shared to both the second and third rotor. As a result each rotor only has to operate above rated power for half as long or only has to deliver half as much additional power in order to compensate for all the lost energy during the drop in wind speed at the first rotor. Further, in the event of larger drops in wind speeds, simultaneous power boosts at the second and third rotor may be able to fully compensate for the temporarily power loss, where a single rotor power boost would not be able to do so.

The timing of the temporarily increase of the power output of the second rotor and of the third rotor may be different, e.g. in order to better stabilize the total wind turbine power output. The difference in timing may be such that the power boosts of the second and third rotor still partially overlap in time, or such that one power boost has already been ended before the other starts.

A further embodiment of the method according to the invention further comprises detecting that the power output of the first rotor returns to its rated capacity, and thereupon controlling operation of the first rotor, such as to temporarily increase its power output to a value above its rated capacity. In this way, the power drop in the first rotor is compensated by at least three of the rotors, which allows for smaller and/or shorter power boosts.

The method according to the invention is mainly used for compensating for power losses when the wind locally and temporarily drops below the rated speed. In order not to put too much mechanical and thermal stress on to the boosted rotors, one or more larger initial power boosts with shorter recovery periods in between may be followed by smaller power boosts and/or longer recovery periods. Similarly, larger power boosts may be used, e.g., when the power output of the first rotor just drops from above to below the rated capacity. When the power output has already been below the rated output power for some time, the probability of the wind speed increasing above rated wind speed soon may be lower and smaller power boosts may be preferred. Also the difference between the current power output level of the first rotor and its rated power output may be taken into account for determining an optimal power boost strategy. When the current power output is just below the rated power output, it is more likely that the wind speed will reach rated wind speed quickly.

In addition to compensating for short-term power drops, the method could also be used when the power output of one of the rotors is below rated power for a longer period of time, e.g., when the first rotor is stopped or derated. For an individual rotor, this may mean that it will operate above rated power for some time. However, the total power output of the rotor collection will remain under the nominal value for the complete system, which may be important for the proper functioning of the shared power electronics and/or the connection to the power grid.

Detecting that the power output of the first rotor is below its rated capacity can be done directly by monitoring the power output of said rotor. Alternatively (or additionally) this may be detected indirectly by detecting that a wind speed in the direct vicinity of the first rotor is below a rated wind speed, or that the rotor speed of the first rotor is below a nominal rotor speed (i.e. the rotor speed corresponding to the nominal output power).

According to a further aspect of the invention, a multirotor wind turbine is provided comprising at least two rotors, each rotor having a rated capacity and comprising a power controller for controlling the power delivered by the respective rotor. The wind turbine comprises a central control unit, operationally coupled to the power controllers of the rotors, the central controller being configured to receive operational data concerning a power output of the rotors, to detect that the power output of at least a first one of the rotors is below its rated capacity, to detect that the power output of at least a second one of the rotors is at its rated capacity, and to control the operation of the second rotor, such as to temporarily increase its power output to a value above its rated capacity.

The multirotor wind turbine comprises four rotors, a first set of two rotors being provided at two arms extending in opposite directions from a wind turbine tower at a first height, a second set of two rotors being provided at two arms extending in opposite directions from the wind turbine tower at a second height, the first height being different from the second height. Wind speeds are often different at different heights. This phenomenon is often called wind shear. Due to wind shear, the top level rotors often experience higher wind speed than the lower level rotors. When the average wind speed or the wind speed halfway between the two rotor heights is close to the rated speed of the rotors, the top level rotors may operate at rated power while the lower level rotors still run at maximum efficiency. In such a situation, power boosts at the higher level rotors may be used to bring the total power output of the wind turbine, closer to its nominal power output.

It will be appreciated that preferred and/or optional features of the first aspect of the invention may be combined with the other aspects of the invention. The invention in its various aspects is defined in the independent claims below and advantageous features are defined in the dependent claims below.

### BRIEF DESCRIPTION OF THE DRAWINGS

For a better understanding of the invention, some embodiments of the invention will now be described with reference to the following drawings, in which:

FIG. 1 schematically shows a multirotor wind turbine in which the invention can be used.

FIG. 2 schematically shows part of a control system for controlling operation of the multirotor wind turbine of FIG. 1.

FIG. 3 shows a flow chart of an exemplary method according to the invention.

FIG. 4 shows two power curves of rotors in the multirotor wind turbine of FIG. 1

### DETAILED DESCRIPTION

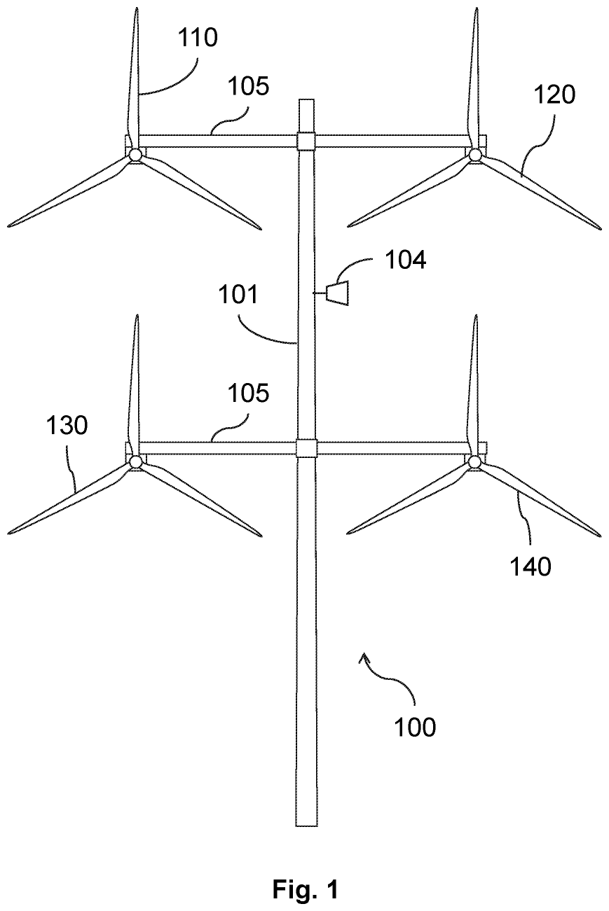

FIG. 1 schematically shows a multirotor wind turbine 100 in which the invention can be used. The currently most common type of wind turbine is the horizontal axis wind turbine (HAWT). It usually has a nacelle placed on top of a high vertical pole, with the rotor blades attached to a horizontal low speed shaft that extends from the nacelle. The nacelle may comprise a gear box for coupling the low speed shaft to an also horizontal high speed shaft that is connected to the generator. Power generated by the generator is transported to the ground by a power line running through the core of the pole, where it can be used or stored immediately or be coupled to a larger power grid. Where, in the past, wind turbines and their rotor blades have grown bigger and bigger to satisfy the increasing demand for wind powered electricity, recently also another strategy has been introduced; the multi-rotor wind turbine 100. Instead of one nacelle with one rotor on the top of the pole, this multi-rotor wind turbine 100 comprises two or more nacelles, here shown with four nacelles 111, 121, 131, 141, each carrying their own rotor 110, 120, 130, 140. In order to avoid the rotor blades of different rotors 110-140 running into each other, the nacelles 111-141 are spaced from each other by attaching them to arms 105, originating from the pole. In this example, the four rotors are arranged in two layers, and each layer can be yawed independently relative to the wind turbine tower 101. While in the current examples all four rotors 110-140 rotate in the same vertical plane, it is also possible to put one or more rotors in different planes. Usually all four rotors 110-140 will be identical, but the invention can also be of use in a multirotor wind turbine comprising two or more different types of rotors, or using multiple rotors of the same type, but in different configurations. E.g., the higher two rotors 110, 120 may be especially configured (in hardware and/or software) for a slightly higher average wind speed than the lower two rotors 130, 140. In the following exemplary embodiments, the multi-rotor wind turbine 100 has two or four rotors 110-140. It is, however, to be noted that a multi-rotor wind turbine, may alternatively comprise 3, 5, 6 or more rotors. In alternative configurations, a wind turbine may comprise a V-shaped support structure on a common base, with a nacelle installed at the outer end of each support arm. Also web-like or honeycomb arrangements can be used for installing multiple nacelles in one construction.

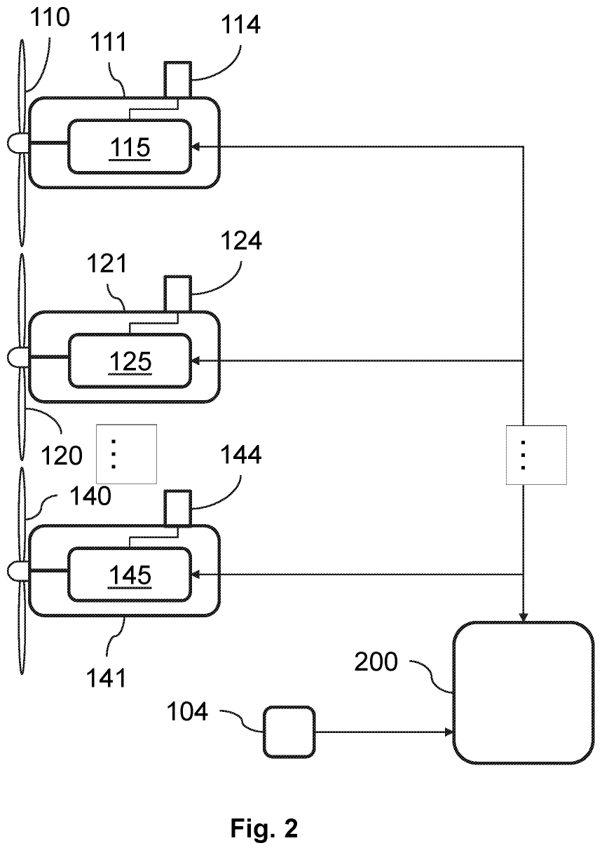

FIG. 2 schematically shows part of a control system for controlling operation of the multirotor wind turbine 100 of FIG. 1. For conciseness only, the third rotor 130 is omitted. In a similar manner, the wind turbine also works with two, three, five or more rotors. Each rotor 110, 120, 140 is electronically coupled to a respective production controller 115, 125, 145. The production controller 115-145 is operable to receive sensor readings from all types of sensors 114, 124, 144, useful for the optimized control of the wind turbine 100. Such sensor readings may represent (and are not limited to) wind speed, speed of rotation, gear box settings, pitch angle, yaw angle and power output. Depending on what they are actually measuring, the sensors 114-144 may, e.g., be installed on the rotor blades, in the rotor hub, in the gearbox or the generator or on a brake or rotor shaft. In a multirotor wind turbine as shown in FIG. 1, yaw angles are usually controlled per level, so yaw control and monitoring are likely to be provided at the connection between the rotor arms 105 and the wind turbine tower 101. Wind speed, for example, may be measured centrally with only one wind sensor 104 and/or at each rotor separately using one or more wind speed sensors installed on each nacelle 111-141. Because wind shear often causes the local wind speed at the upper level rotors 110, 120 to be different from the local wind speed at the lower level rotors 130, 140, central wind sensors 104 are usually placed halfway between the two levels. The wind speed measured by such a central sensor 104 is usually referred to as the half-height wind speed

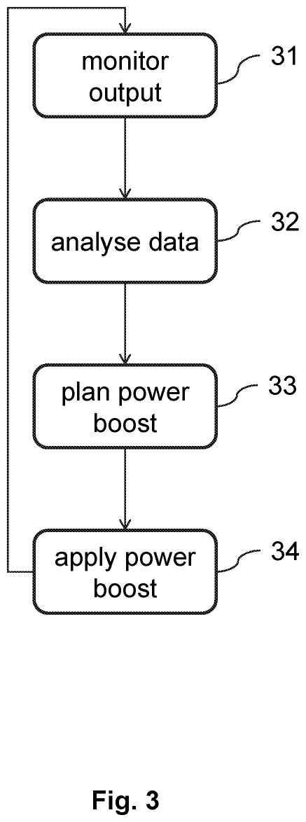

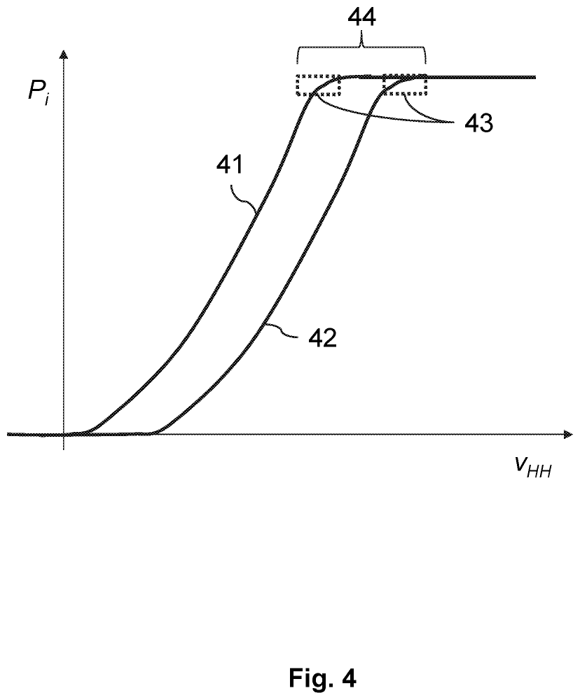

The production controller 115-145 processes, and optionally stores, all the incoming sensor information and adjusts control settings like desired pitch angle, yaw angle and speed of rotation in such a way to control and optimize the power output of the rotor 110-140. Specific examples of control strategies are described below with reference to FIGS. 3 and 4. It is to be noted that the production controller 115-145 is not necessarily a single unit harbouring all control functions of the wind turbine 100. Separate control functions may be provided by separate control units For example, a pitch control system may be provided in the rotor hub, close to the pitch control mechanism, apart from a production controller 115-145 elsewhere in the nacelle 111-141. In this schematic representation, the production controllers 115-145 are situated inside the respective nacelles 111-141 of their rotors, but alternative setups are foreseeable. For example, a central control unit 200 may be provided for controlling the power production of each one of the rotors 110-140, or all data may be communicated wirelessly to a cloud server that processes the incoming data and returns control instructions via the same or a similar communication signal.

Central control unit 200 receives operational data from the production controllers 115-145. Data that may be used for the method of the invention is, e.g., current power output (P,), rotor blade pitch, local wind speed, and generator and converter temperatures. The central control unit 200 may be provided at a central location in the tower 101 or the tower base of the wind turbine. Alternatively, the central control unit 200 is provided in one of the nacelles or at a remote location. The functionality of the central control unit 200 may be distributed over multiple controllers at different locations and/or be embodied in one or more controllers that are already present for other purposes. With the operational data from the different nacelles 111-141, the central control unit 200 determines which rotors 110-140 are instructed to deliver a power boost. As will be described in detail below, with reference to FIGS. 3 and 4, the power boosts can be controlled in timing, duration and boost level in dependence of the circumstances.

FIG. 3 shows a flow chart of an exemplary method according to the invention. The flow chart shows a continuous process that starts with a monitoring step 31 and ends with boost control step 34 in which one or more rotors 110-140 may be instructed to provide a power boost. The power boosts will affect the power output of the rotors 110-140 and internal operational parameters, such as the generator and converter temperatures. Wind conditions and other external factors also change continuously, so the monitoring 31 continues after the power boost commands have been sent to the nacelles 111-141. In practice, changed circumstances may cause an already instructed power boost to be cancelled, delayed or otherwise adapted before it is executed.

The monitoring step 31 involves obtaining operational data, such as e.g., current power output (Pᵢ), rotor blade pitch, local wind speed, and generator and converter temperatures from the nacelles. Additionally, the monitoring 31 may include obtaining data from sensors on the wind turbine tower 101 or rotor arms 105 or receiving information and instructions from a central power grid control system. For example, a central wind sensor 104 may be provided halfway between the upper and lower rotor levels in order to measure the half-height wind speed (v_{HH}). It is noted that the input data used for determining where and when to provide a power boost is certainly not limited to the explicit examples provided here.

In a data analysis step 32, the incoming data is analysed in order to detect when the power output (Pi) of at least one of the rotors 110-140 falls below its nominal power. This may be done directly, based on power output data, but also indirectly through analysis of the local wind speed at or near the respective rotors 111-141. When the local wind speed drops below rated speed, it can be concluded that the power output is below the nominal power output. Alternatively, a signal indicating that one of the rotors is shutdown or derated can be used for detecting a power drop. Power drops can also be detected by monitoring the total power output of the multirotor wind turbine 100. However, additional information will be needed for subsequently planning a power boost strategy that can be applied to stabilize this wind turbine power output. When information is available about which rotors 110-140 are operating at and below nominal output power, a power boost strategy can be planned in subsequent boost planning step 33.

In the boost planning step 33, a power boost strategy is generated for reducing the unwanted effects of the temporary power drop. During a power boost, the rotor is configured to deliver some extra power during a limited time period. This is generally done by pitching the rotor blades a little bit further into the wind such the thrust on the blades and therewith the rotational speed of the rotor increases. A typical power boost capacity for a single rotor is about 5%. The extra power can be delivered over a limited time period of, e.g., 60 seconds without risking excessive wear of wind turbine parts like the generator and the power converter. After a power boost, the rotor needs a recovery period to cool down to its normal operation temperature before a new power boost can be started. In the following, we will assume a 5% boost capacity for all rotors, but in practice the boost capacity may be smaller or larger. Also, lower boosts may be maintained for a longer time period, before recovery is needed and incidental higher boosts are possible when accepting the additional wear on some of the wind turbine components.

According to the invention, power boosts for different rotors in a multirotor wind turbine are coordinated in such a way as to improve the overall performance of the multirotor wind turbine. The exact strategy that is applied will differ between different multirotor wind turbines and depends on, e.g., external circumstances and operational constraints that may be set centrally or locally. The strategy may, e.g., be optimised for maximizing the daily energy production, for stabilizing the total wind turbine power output or for optimizing wind turbine durability.

Below, some exemplary strategies for achieving such optimizations are disclosed. In practice, the power boost strategy may be designed to provide a suitable compromise between two or more of the above, which will require a mixture of the control measures described.

### Stable Wind Turbine Power Output

For a wind turbine, integrated in a wind park and/or connected to a shared power grid, it is important to deliver a constant and reliable power output. The nominal power output of a multirotor wind turbine is the sum of the nominal outputs of the separate rotors it comprises. One objective of the power boost strategy to be implemented may be to have the wind turbine deliver its nominal output power for as much time as possible and to deliver an as close as possible power output for the time remaining. When there is not enough wind (wind speed well below rated wind speed), the total power output will be lower. With a wind speed well above the rated wind speed, all four rotors operate at their nominal output level. When due to turbulence and/or a local drop in wind speed, the output of one or more of the rotors 110-140 drops below its nominal output power, the following exemplary strategies may be used for keeping the total power output at or as close as possible to the nominal power output:
At detection of the power drop, immediately initiating full capacity (e.g. 5%) power boosts at all rotors 110-140 that still operate at their nominal power output. This strategy may be useful in the event that it is expected that the power drop is just temporary and will not last very long, e.g. in the event of a sudden and unexpected large drop in wind speed at only one of the rotors.
The power boosts may be time shifted, such that all boostable rotors are boosted sequentially. Although the total amount of extra power that may be added by such boosts will be limited, the added power can be delivered over a longer time span and the total power output of the wind turbine will be more stable. This strategy may be very useful in the event of sustained periods of lower wind speeds, e.g. when the lower level wind speed is just below rated speed because of wind shear.
If there is more power boost capacity than needed to compensate for the power drop, the boosts may deliver less than the full capacity, e.g. 3% each. An advantage of a lower power boost is that it may be maintained for a longer period of time before recovery is needed to avoid excessive wear of the wind turbine parts. As an alternative to longer power boosts, the recovery period can be reduced.
Excess power boost capacity can also be used for sequentially boosting different rotors, such that the total length of the power boost is increased.

### Maximum Energy Production

In the end, the most important commercial parameter of a wind turbine is the amount of electrical energy it produces per unit of time, e.g. per year. With this objective in mind, not using the full power boost capacity of each rotor is not a preferred option. If the main goal of the power boost strategy is to minimize the lost energy production during a local drop in wind speed, it is useful to distribute the power boosts of separate rotors over time. This will avoid the boost capacity exceeding the size of the power drop and makes it possible to continue delivering additional electrical energy while the other rotors are recovering from an earlier power boost.

### Wind Turbine Durability

When wind turbine durability has the highest priority, shorter and smaller power boosts are preferred, which makes it even more important to distribute the desired power boost activity over all rotors. Including the rotor experiencing the temporary drops in wind speed in the power boost strategy can allow for temporarily derating the other rotors and further reducing the mechanical and thermal stress on each rotor. By not exceeding the nominal total power output of the full multi-rotor wind turbine, also the stress on shared components, such as e.g. a central power converter or a wind turbine power output cable, is minimized.

For the strategies listed above, it is assumed that the total power output of the multirotor wind turbine is expected not to exceed the nominal power output level of the wind turbine, e.g. due to network constraints. If such constraints are not in place, the additional power from the power boosts may temporarily exceed the lost power of the power drop. Even though the network may allow this, it may still be better to time the power boosts from different rotors in such a way as to not overlap each other in order to prevent excessive wear of common parts, such as a central power converter of main power cable.

Also, if a particular rotor of the multirotor wind turbine experiences a variable wind speed just around the rated wind speed, it may be useful to power boost this rotor in the ‘classical’ way, i.e. to generate a power boost as soon as the wind speed returns above the rated speed. This may even be useful when at that moment all other rotors are operating at nominal power, If the network allows the temporary exceedance of the nominal power output of the wind turbine, this can be done without any additional measures taken. When the total power output of the wind turbine is to be limited, this ‘classical’ power boost may allow derating one or more of the other rotors hi for enabling a faster recovery and to ensure that the other rotors are ready for a new power boost in the event that the local wind speed will drop below rated speed again,

FIG. 4 shows two power curves of rotors in the multirotor wind turbine of FIG. 1, which illustrate some of the main advantages of the current invention. The power curves show the relation between wind speed and single rotor power output. The wind speed used in this figure, is the wind speed as measured by the central wind speed sensor 104 located at the wind turbine tower 101, midway between the upper and lower level rotor arms. The speed measured at this position is referred to as half height wind speed (v_{HH}). Because of wind shear, the wind speed at ground level is different from the wind speed closer to the top of the wind turbine tower 101, The power curve 41 on the left shows the relation between the power output of an upper level rotor 110, 120 and the half height wind speed. The power curve 42 on the right does the same for the lower level rotors 130, 140.

In general, different zones can be observed in a wind turbine power curve 41, 42. Below the cut-in speed, there is insufficient torque exerted by the wind on the turbine blades to make them rotate and to generate power. When the wind speed increases beyond the cut-in speed, we enter a second zone in which the rotor starts producing power and the power output rises rapidly with further increasing wind speeds, The third zone starts at rated wind speed. Beyond the rated wind speed, a further increase in power output would lead to excessive torques on the powertrain and heat generation in, e.g., the generator and the power converter. Therefore, the pitch of the rotor blades is adapted in order to keep the power output constant with increasing wind speeds. In a fourth zone (not shown), wind speeds may become so high that it is safer to shut down the wind turbine completely and bring the power output to 0.

For a single rotor, power boosts are typically useful when the wind speed is close to rated wind speed. Fluctuations in wind speed and local turbulences then cause the wind speed to regularly drop below and climb above the rated wind speed. The power boost is applied when the wind speed rises above rated speed for a temporary increase of output power. If these power boosts are sufficiently frequent and large enough, they can at least partly compensate for the power drops occurring when the wind speed temporarily drops below rated speed, keeping the average power output at its rated value. Power boosts can thus be used to increase a rotor's energy output when the wind speed is in a narrow range in the transition region 43 between the second and third zone.

In a multirotor wind turbine 100, each rotor has its own transition region in which power boosts can increase the average output power of the respective rotor. Because the individual rotors of a multirotor wind turbine 100 are usually of the same type, their transition regions will cover the same range of wind speeds. Due to wind shear, however, there is wider transition region 44 in which the upper level rotors 110, 120 already operate at or around rated wind speed, while the lower level rotors 130, 140 may not there yet. In that situation, power boosts at the upper level rotors 110, 120 can be used for not just compensating upper level local drops in wind speeds, but also for lower wind speeds at the lower level rotors 130, 140. As a result, the average power output of the multirotor wind turbine 101 is increased, without having to exceed the nominal output power of the wind turbine as a whole. In practice, it has been observed that 5-10% of the time the upper level rotors 110, 120 operate completely in the third zone, while the lower level rotors 130, 140 operate below or around rated wind speed.

Although some vertical wind shear will almost always be present, the extent to which the wind speeds at the upper and lower level of the multirotor wind turbine 100 differ varies over time. It may therefore be difficult to find an optimal power boost strategy based on the half-height wind speed alone. Better results can be expected from power boost control methods that take into account the respective power outputs, rotor speeds and/or local wind speeds of the different rotors.

It will be appreciated that preferred and/or optional features of the first aspect of the invention may be combined with the other aspects of the invention. The invention in its various aspects is defined in the independent claims below and advantageous features are defined in the dependent claims below.

1. A method of operating a multi-rotor wind turbine, the wind turbine comprising a wind turbine support structure and a collection of wind turbine rotors comprising at least two rotors, at least one of the rotors being located at a position away from a central longitudinal axis of the wind turbine support structure, each rotor having a rated capacity, the method comprising:
monitoring a power output of the rotors,
detecting that the power output of at least a first one of the rotors is below its rated capacity,
detecting that the power output of at least a second one of the rotors is at its rated capacity, and
controlling operation of the second rotor, such as to temporarily increase its power output to a value above its rated capacity.

2. The method of claim 1, wherein the collection of wind turbine rotors further comprises at least a third rotor with a rated capacity, the method further comprising a step of
detecting that the power output of the third rotor is at its rated capacity, and
controlling operation of the third rotor, such as to temporarily increase its power output to a value above its rated capacity.

3. The method of claim 2, wherein a timing of the temporary increase of the power output of the second rotor and of the third rotor are different.

4. The method of claim 3, wherein the temporary increase of the power output of the second rotor and of the third rotor do not overlap in time.

5. The method of claim 1, wherein a timing of the temporary increase of the power output of the second rotor is such as to immediately follow the detecting that the power output of the first rotor is below its rated capacity and that the power output of the second rotor is at its rated capacity.

6. The method of claim 1, wherein the detecting that the power output of the first rotor is below rated capacity includes detecting that it changes from above rated capacity to below rated capacity.

7. The method of claim 1, further comprising:
detecting that the power output of the first rotor returns to its rated capacity, and
thereupon controlling operation of the first rotor, such as to temporarily increase its power output to a value above its rated capacity.

8. The method of claim 1, wherein detecting that the power output of the first rotor is below its rated capacity includes detecting that the first rotor is stopped or derated.

9. The method of claim 1, wherein detecting that the power output of the first rotor is below its rated capacity includes detecting that a wind speed in the direct vicinity of the first rotor is below a rated wind speed.

10. The method of claim 1, wherein detecting that the power output of the first rotor is below its rated capacity includes detecting that a rotor speed of the first rotor is below a nominal rotor speed.

11. A multi-rotor wind turbine comprising a wind turbine support structure and a collection of wind turbine rotors comprising at least two rotors, at least one of the rotors being located at a position away from a central longitudinal axis of the wind turbine support structure each rotor having a rated capacity and comprising a power controller for controlling the power delivered by the respective rotor, the collection of wind turbine rotors comprising a central control unit, operationally coupled to the power controllers of the rotors, the central controller being configured to:
receive operational data concerning a power output of the rotors,
detect that the power output of at least a first one of the rotors is below its rated capacity,
detect that the power output of at least a second one of the rotors is at its rated capacity, and
control operation of the second rotor, such as to temporarily increase its power output to a value above its rated capacity.

12. The multi-rotor wind turbine as claimed in claim 11, wherein the collection of wind turbine rotors comprising four rotors, a first set of two rotors being provided at two arms extending in opposite directions from a wind turbine tower at a first height, a second set of two rotors being provided at two arms extending in opposite directions from the wind turbine tower at a second height, the first height being different from the second height.

13. The wine turbine of claim 11, wherein the collection of wind turbine rotors further comprises at least a third rotor with a rated capacity, the central controller being further configured:
detect that the power output of the third rotor is at its rated capacity, and
control operation of the third rotor, such as to temporarily increase its power output to a value above its rated capacity.

14. The wind turbine of claim 13, wherein a timing of the temporary increase of the power output of the second rotor and of the third rotor are different.

15. The controller of claim 14, wherein the temporary increase of the power output of the second rotor and of the third rotor do not overlap in time.

16. A multi-rotor wind turbine controller, comprising:
one or more processors;
a memory containing instructions; wherein, when executed, the instructions configure the one or more processors to perform an operation, comprising:
monitoring a power output of at least two rotors of the multi-rotor wind turbine, wherein at least one of the rotors is located at a position away from a central longitudinal axis of a wind turbine support structure of the multi-rotor wind turbine;
detecting that the power output of at least a first one of the rotors is below its rated capacity;
detecting that the power output of at least a second one of the rotors is at its rated capacity, and
controlling operation of the second rotor, such as to temporarily increase its power output to a value above its rated capacity.

17. The controller of claim 16, wherein the collection of wind turbine rotors further comprises at least a third rotor with a rated capacity, the operation further comprising:
detecting that the power output of the third rotor is at its rated capacity, and
controlling operation of the third rotor, such as to temporarily increase its power output to a value above its rated capacity.

18. The controller of claim 17, wherein a timing of the temporary increase of the power output of the second rotor and of the third rotor are different.

19. The controller of claim 18, wherein the temporary increase of the power output of the second rotor and of the third rotor do not overlap in time.

20. The controller of claim 16, wherein a timing of the temporary increase of the power output of the second rotor is such as to immediately follow the detecting that the power output of the first rotor is below its rated capacity and that the power output of the second rotor is at its rated capacity.
